(19) United States
(12) Patent Application Publication
(10) Pub. No.: US 2026/0142232 A1
(43) Pub. Date: May 21, 2026

(54) POLYMER ELECTROLYTE

(71) Applicants: TOYOTA JIDOSHA KABUSHIKI KAISHA, Toyota-shi (JP); Deakin University, Geelong (AU)

(72) Inventors: Azusa NAKANISHI, Susono-shi (JP); Maria Forsyth, Geelong (AU); Patrick Howlett, Geelong (AU)

(73) Assignees: TOYOTA JIDOSHA KABUSHIKI KAISHA, Toyota-shi (JP); Deakin University, Geelong (AU)

(21) Appl. No.: 19/384,052

(22) Filed: Nov. 10, 2025

(30) Foreign Application Priority Data
Nov. 15, 2024 (JP) 2024-200001

(51) Int. Cl. H01M 10/0565

(52) U.S. Cl. CPC H01M 10/0565; H01M 2300/0082

(57) ABSTRACT

The present disclosure relates to a polymer electrolyte. The polymer electrolyte includes a lithium salt polymer including an anionic functional group and a salt with lithium, and a substance having plastic crystal properties. The present disclosure provides the polymer electrolyte improved in electrical performance, in particular, the polymer electrolyte improved in lithium ion transport number.

### CROSS-REFERENCE TO RELATED APPLICATION

This application claims priority to Japanese Patent Application No. 2024-200001 filed on Nov. 15, 2024. The disclosure of the above-identified application, including the specification, drawings, and claims, is incorporated by reference herein in its entirety.

### BACKGROUND

### 1. Technical Field

The present disclosure relates to a polymer electrolyte including a polymer and a substance that exhibits plastic crystal properties.

### 2. Description of Related Art

In recent years, non-aqueous electrolyte batteries using polymer electrolytes have been attracting attention. In particular, those using lithium have been attracting attention because of high energy density and ability to generate a high electromotive force. Polymer electrolytes have advantages such as ease of processing, low density and therefore low mass, and the potential for green batteries using renewable resources for synthesis.

Related-art polymer electrolytes include, for example, a polymer composition containing a thermoplastic copolyester, a metal salt, and an organic nitrile component in certain weight percentages (see, for example, Japanese Unexamined Patent Application Publication (Translation of PCT Application) No. 2021-514095 (JP 2021-514095 A)). The polymer composition of JP 2021-514095 A can achieve an excellent electrical conductivity level.

A substance having plastic crystal properties, such as succinonitrile (SN), is considered for use in environmentally friendly solid-state batteries. Although SN is often used as an additive in polymer electrolytes to increase ionic conductivity, SN itself can also be applied as a solid electrolyte having ion conductivity up to 10⁻⁴ S/cm at room temperature. SN-based electrolytes may be insufficient in dimensional stability and may have a problem of a high tendency of SN sublimation. It has been demonstrated that material properties such as mechanical stability can be improved by varying the molecular structure and concentration of a lithium salt or by adding a polymer.

Vanessa van Laack, et al. “Succinonitrile-Polymer Composite Electrolytes for Li-Ion Solid-State Batteries—The Influence of Polymer Additives on Thermomechanical and Electrochemical Properties.” ACS OMEGA Volume 8, Issue 10 (2023): 9058-9066. describes the influence of polymers on the thermomechanical and electrochemical properties of SN-based electrolytes, and describes that the presence of a polymer such as polyethylene oxide (PEO) shifts the onset of the SN sublimation process to a higher temperature and increases the mechanical strength.

### SUMMARY

The related-art polymer electrolytes including a polymer and a substance having plastic crystal properties, such as succinonitrile, may be unable to obtain sufficient electrical performance, in particular, may be insufficient in lithium ion transport number.

In this background, the present disclosure has an object to provide a polymer electrolyte improved in electrical performance (in particular, lithium ion transport number).

The object of the present disclosure can be achieved by the following aspects of the present disclosure:

### First Aspect

A polymer electrolyte including a lithium salt polymer including an anionic functional group and a salt with lithium, and a substance having plastic crystal properties.

### Second Aspect

The polymer electrolyte according to the first aspect, in which the anionic functional group of the lithium salt polymer is present on a side chain of the lithium salt polymer.

### Third Aspect

The polymer electrolyte according to the first or second aspect, in which the substance having plastic crystal properties is succinonitrile.

### Fourth Aspect

The polymer electrolyte according to any one of the first to third aspects, in which the anionic functional group of the lithium salt polymer includes a sulfonimide skeleton or an imide skeleton.

### Fifth Aspect

The polymer electrolyte according to any one of the first to fourth aspects, in which the lithium salt polymer is poly((trifluoromethane)sulfonimide lithium methacrylate) or poly((trifluoromethane)sulfonimide lithium styrene).

The present disclosure provides the polymer electrolyte improved in electrical performance, in particular, the polymer electrolyte improved in lithium ion transport number.

### DETAILED DESCRIPTION OF EMBODIMENTS

### Polymer Electrolyte

The polymer electrolyte according to the present disclosure includes a lithium salt polymer including an anionic functional group and a salt with lithium, and a substance having plastic crystal properties.

Related-art lithium ion conductive polymer electrolytes are polymer electrolytes each containing a polymer and a substance having plastic crystal properties, such as succinonitrile. Such a polymer electrolyte uses a low molecular weight lithium salt such as lithium bis(trifluoromethanesulfonyl)imide (LiTFSI), and therefore has a problem in that sufficient electrical performance cannot be obtained, in particular, the lithium ion transport number is insufficient.

The polymer electrolyte according to the present disclosure uses a polyanion lithium salt in which an anionic functional group is fixed to a polymer, and has an improved lithium cation transport number. Without being limited by theory, it is believed that, in the related-art polymer electrolytes, the anion of the lithium salt easily diffuses due to the low molecular weight, and therefore both the lithium salt and the anion in the polymer electrolyte move, for example, during operation of the battery, resulting in the low transport number. In the present disclosure, it is believed that the anion is immobilized on the polymer and is therefore less likely to diffuse, thereby improving the lithium cation transport number.

In the polymer electrolyte of the present disclosure, a solid electrolyte that is both conductive and moldable can be obtained by including the polymer in addition to the substance having plastic crystal properties.

Each component of the inventive aspects of the present disclosure is described in more detail below.

### Lithium Salt Polymer

The polymer electrolyte according to the present disclosure includes the “lithium salt polymer.” The “lithium salt polymer” includes the anionic functional group, and forms a salt with lithium via the anionic functional group. By including such a lithium salt polymer in addition to the substance having plastic crystal properties, the present disclosure can attain the improved lithium cation transport number, and can also attain a polymer electrolyte having appropriate flexibility, moldability, and ease of processing. The lithium salt polymer may include anionic constitutional units (repeating units).

The molar ratio of the lithium salt polymer to the substance having plastic crystal properties in the polymer electrolyte may be, for example, 1:2 to 1:6, and preferably 1:3 to 1:5.

The lithium salt polymer according to the present disclosure may have an average molecular weight of 1500 to 1000000, or even 5000 to 300000. The average molecular weight of the polymer is a weight average molecular weight (Mw). The weight average molecular weight (Mw) of the polymer can be measured by gel filtration chromatography.

The lithium salt polymer according to the present disclosure can be obtained, for example, by polymerizing a monomer mixture containing a monomer including an anionic functional group. In this case, the obtained polymer includes anionic constitutional units (repeating units). Examples of the anionic constitutional unit include anionic constitutional units included in chemical formulae (II) to (V) described later.

The lithium salt polymer may include a constitutional unit (unit, or repeating unit) that does not include an anionic functional group. In this case, the proportion of the anionic constitutional unit including an anionic functional group among all the constitutional units constituting the polymer is preferably 70% to 100%, more preferably 80% to 100%, and even more preferably 90% to 100%. In particular, the lithium salt polymer may be composed of the anionic constitutional units including anionic functional groups.

The polymer according to the present disclosure may include a plurality of anionic functional groups in one molecule.

The lithium salt polymer may be present at 1 mol % to 50 mol %, 5 mol % to 40 mol %, or even 10 mol % to 30 mol %, and preferably more than 10 mol % and less than 30 mol %, 12 mol % to 28 mol %, 15 mol % to 25 mol %, or 20 mol %, with respect to the total number of moles of the lithium salt polymer and the substance having plastic crystal properties.

In the polymer electrolyte according to the present disclosure, the lithium salt polymer and the substance having plastic crystal properties are preferably contained in a total amount of at least 80 mass %, or even 90 mass % or 95 mass %, and more preferably, the polymer electrolyte according to the present disclosure consists of the lithium salt polymer and the substance having plastic crystal properties.

### Anionic Functional Group

The lithium salt polymer according to the present disclosure includes the anionic functional group to form a salt with lithium. It is believed that the anion is immobilized on the polymer and is less likely to diffuse, thereby improving the lithium ion transport number.

Examples of the anionic functional group include carboxylate (COO⁻), sulfonate (SO₃⁻), ClO₄⁻, SCN⁻, BF₄, AsF₆⁻, CF₃SO₃⁻, Br, I⁻, PF₆⁻, CF₃CO₂⁻, (FO₂S)₂N⁻ also known as FSI, bis(oxalate)borate also known as BOB, —SO₂—N⁻—SO₂—CF₃, and —SO₂—C⁻—SO₂—CF₃. The anionic functional group is particularly preferably —SO₂—N⁻—SO₂—CF₃.

### Side Chain

In one embodiment, the lithium salt polymer includes the anionic functional group on the side chain. Examples of the anionic functional group present on the side chain include those listed above.

When the polymer includes the anionic functional group on the side chain, examples of the polymer backbone include polymethacrylate, polyacrylate, polystyrene, polystyrene sulfonate, polyethylene oxide (PEO), polyvinylpyrrolidone (PVP), polyacrylonitrile (PAN), and poly(vinylidene fluoride-co-hexafluoropropylene) (PVDF-HFP).

The anionic functional group present on the side chain may be bonded directly to the polymer backbone, or may be connected via a linker group. Examples of the linker group include an alkylene group (in particular, having 1 to 6 carbon atoms or even 1 to 4 carbon atoms), a phenylene group, and an acrylate group.

The anionic functional group preferably includes a sulfonimide skeleton or an imide skeleton. For example, a specific chemical structure of sulfonimide located on the side chain is shown in structural formula (I). In structural formula (I), * indicates a bond to the polymer backbone or to the linker group.

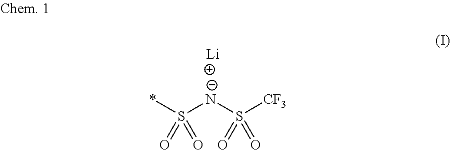 [SMILES: [Li+] ; *S(=O)(=O)[N-]S(=O)(=O)C(F)(F)F]

### Specific Embodiments of Lithium Salt Polymer

Examples of the lithium salt polymer according to the present disclosure include poly((trifluoromethane)sulfonimide lithium methacrylate) (PMTFSI-Li), poly((trifluoromethane)sulfonimide lithium styrene) (PSTFSI-Li), lithium polyacrylate, lithium polystyrene sulfonate, and mixtures thereof. The lithium salt polymer is preferably PMTFSI-Li or PSTFSI-Li.

Structural formula (II) of poly((trifluoromethane)sulfonimide lithium methacrylate) (PMTFSI-Li) is shown below. In this formula, n may be 5 to 500.

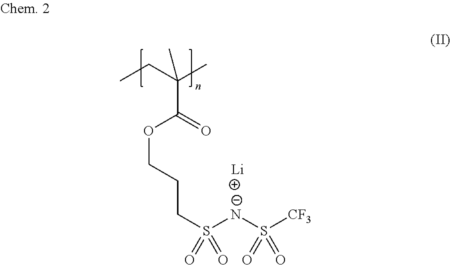

Structural formula (III) of poly((trifluoromethane)sulfonimide lithium styrene) (PSTFSI-Li) is shown below. In this formula, n may be 5 to 500.

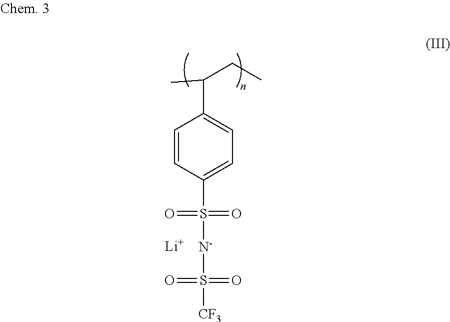

Structural formula (IV) of lithium polyacrylate is shown below. In this formula, n may be 5 to 500.

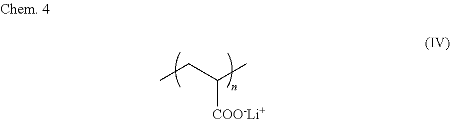

Structural formula (V) of lithium polystyrene sulfonate is shown below. In this formula, n may be 5 to 500.

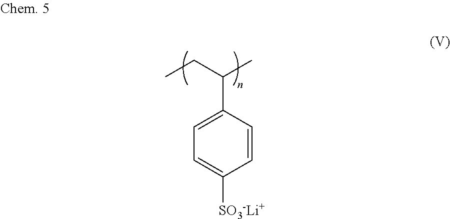

### Substance Having Plastic Crystal Properties

The polymer electrolyte according to the present disclosure includes the substance (particularly a compound) having plastic crystal properties. The “plastic crystal properties” refer to intermediate properties between a liquid and a solid, in which the position of the crystal is fixed but the crystal undergoes rotational motion etc. to have mobility. This allows ions to be conducted at high speed even in a solid state.

In particular, the substance (particularly a compound) having plastic crystal properties is an organic nitrile. The “organic nitrile” is understood as an organic compound containing a nitrile functional group also called cyano functional group, such as acrylonitrile or propanenitrile, or a mixture thereof. The organic nitrile may be a compound containing a plurality of nitrile groups and/or may be a mixture of a plurality of compounds each containing a nitrile group. The use of nitrile reduces interactions with lithium ions.

In a preferred embodiment of the present disclosure, the substance (compound) having plastic crystal properties is preferably an aliphatic dinitrile such as adiponitrile (AN) and/or succinonitrile (SN) because of an advantage of high conductivity. The substance having plastic crystal properties is more preferably succinonitrile (SN), which is particularly advantageous in an increased conductivity of the composition over a wide temperature range.

The substance having plastic crystal properties may have a molecular weight of less than 2000 g/mol, more preferably less than 1000 g/mol, even more preferably less than 500 g/mol, and most preferably less than 250 g/mol. The lower limit of the molecular weight is not limited, but may be, for example, 60 g/mol or more. The molecular weight of the substance having plastic crystal properties may be determined by mass spectrometry methods known in the art.

The substance having plastic crystal properties may be, for example, 50 mol % to 95 mol %, or even 60 mol % to 99 mol %, with respect to the total number of moles of the substance having plastic crystal properties and the lithium salt polymer. The substance having plastic crystal properties is preferably present at more than 70 mol % and less than 90 mol %, in particular, 71 mol % or more, 72 mol % or more, 73 mol % or more, 74 mol % or more, 75 mol % or more, 76 mol % or more, 77 mol % or more, 78 mol % or more, or 79 mol % or more and/or 89 mol % or less, 88 mol % or less, 87 mol % or less, 86 mol % or less, 85 mol % or less, 84 mol % or less, 83 mol % or less, 82 mol % or less, or 81 mol % or less, with respect to the total number of moles of the substance having plastic crystal properties and the lithium salt polymer. At more than 70 mol %, more satisfactory ion conductivity can be obtained. At less than 90 mol %, particularly satisfactory low-temperature properties can be obtained.

The plastic crystal properties can be determined, for example, using differential scanning calorimetry (DSC). Specifically, the plastic crystal properties can be determined, for example, by showing an endothermic peak associated with phase transition from the crystal phase to the plastic crystal phase and an endothermic peak associated with melting during a temperature rise process (e.g., from −80° C. to 150° C.) at a temperature rise rate of 10° C./min in DSC using a differential scanning calorimeter.

### Method for Producing Polymer Electrolyte

The method for producing the polymer electrolyte according to the present disclosure is not particularly limited. For example, the polymer electrolyte can be produced by a method including the following steps:
(a) providing a lithium salt polymer;
(b) providing a substance having plastic crystal properties; and
(c) mixing the lithium salt polymer with the substance having plastic crystal properties to form a polymer electrolyte.

### Step a

In step a, a lithium salt polymer is provided. For the lithium salt polymer, reference may be made to the above description of the polymer electrolyte.

For example, the lithium salt polymer can be obtained by a process including polymerizing a monomer mixture containing a monomer including an anionic functional group. In this case, the obtained polymer includes anionic constitutional units (or repeating units).

The lithium salt polymer may include a constitutional unit that does not include an anionic functional group. In this case, the proportion of the anionic constitutional unit including an anionic functional group among all the constitutional units constituting the polymer is preferably 70 mol % to 100 mol %, more preferably 80 mol % to 100 mol %, and even more preferably 90 mol % to 100 mol %. In particular, the lithium salt polymer may be composed of the anionic constitutional units including anionic functional groups.

### Step b

In step b, a substance having plastic crystal properties is provided. For the substance having plastic crystal properties, reference may be made to the above description of the polymer electrolyte according to the present disclosure.

### Step c

In step c, the lithium salt polymer is mixed with the substance having plastic crystal properties to form a polymer electrolyte. The mixing method is not particularly limited, and any known method can be used. A solvent such as an organic solvent (e.g., acetonitrile) may be used for the mixing.

The mixing ratio of the lithium salt polymer and the substance having plastic crystal properties can be determined as appropriate, for example, to provide a suitable ratio of these substances described above about the polymer electrolyte of the present disclosure.

The mixing may be carried out, for example, at a temperature of 40° C. to 80° C., preferably 50° C. to 70° C., for 20 hours to 30 hours, preferably 23 hours to 27 hours.

In one embodiment, the lithium salt polymer and the substance having plastic crystal properties may be mixed by stirring and dissolving in an organic solvent (e.g., acetonitrile), for example, for 23 hours to 27 hours. In this case, the solution obtained by the mixing is left to stand still at a temperature of, for example, 40° C. to 60° C., preferably 45° C. to 55° C., to volatilize the organic solvent, and then dried, for example, under vacuum at a temperature of, for example, 40° C. to 60° C., preferably 45° C. to 55° C., thereby obtaining a polymer electrolyte.

### Applications of Polymer Electrolyte

The polymer electrolyte according to the present disclosure can be used in a solid-state battery, in particular, an all-solid-state battery. In the present disclosure, the “solid-state battery” refers to a battery that uses at least a solid electrolyte as the electrolyte. Therefore, the solid-state battery may use a combination of the solid electrolyte and a liquid electrolyte as the electrolyte. The solid electrolyte including the polymer electrolyte, in particular, the all-solid-state battery, can be produced by any known method.

The polymer electrolyte according to the present disclosure is used, for example, as a composite material in an electrode, in particular, an electrode for a rechargeable battery. In the present disclosure, the “composite material” refers to a composition that can constitute a cathode active material layer etc. either as it is or by further containing other components. In the present disclosure, a “composite material slurry” refers to a slurry that contains a dispersion medium in addition to the “composite material” and that can be applied and dried to form a cathode active material layer etc.

When the polymer electrolyte according to the present disclosure is used in, for example, an electrode laminate in a thin-film all-solid-state battery, the polymer electrolyte may be produced by a method in which a cathode active material layer is formed on a substrate, a solid electrolyte layer and an anode active material layer are formed in this order, and then the layers are laminated. Other modifications of the process are also conceivable. The polymer electrolyte of the present disclosure can be used in both primary and secondary batteries. The all-solid-state battery manufactured using the polymer electrolyte of the present disclosure may generally include a separator, a cathode terminal connected to a cathode current collector, an anode terminal connected to an anode current collector, etc. in addition to the above members. The materials and shapes of the cathode, the anode, and the other members can be selected as appropriate by those skilled in the art depending on the application of the battery.

Polymer electrolytes according to Examples 1 and 2 and Comparative Example 1 were produced, evaluation cells were produced using the obtained polymer electrolytes, and the lithium ion transport numbers were evaluated.

### Example 1: PMTFSI-Li+SN

In Example 1, a polymer electrolyte was prepared using a lithium salt polymer (PMTFSI-Li) in which a (trifluoromethane)sulfonimide lithium (TFSI) group was bonded to a methacrylate backbone as a side chain anionic functional group, and using succinonitrile (SN) as the substance having plastic crystal properties.

### Preparation of Polymer Electrolyte

In an Ar atmosphere glove box, succinonitrile and poly((trifluoromethane)sulfonimide lithium methacrylate) (PMTFSI-Li, produced by Polykey, Spain) were weighed out such that the molar ratio of SN to PMTFSI-Li was 4:1, and the substances were dissolved in acetonitrile (produced by Sigma-Aldrich) by stirring for 24 hours. The obtained solution was left to stand still on a hot plate at 50° C. to volatilize acetonitrile, and then dried under vacuum at 50° C., thereby obtaining a polymer electrolyte.

### Measurement of Lithium Ion Transport Number

The obtained polymer electrolyte was heated to 60° C. and impregnated into a polypropylene separator. A coin cell was prepared with a configuration of Li metal, separator, and Li metal using the separator impregnated with the polymer electrolyte. The prepared coin cell was left to stand still in a thermostatic chamber at 50° C. for 12 hours. After standing still, alternating-current impedance was measured at 50° C. from 1 Hz to 1 MHz using VMP3 (manufactured by Biologic). The resistance measured at this time was represented by RO. Subsequently, direct-current polarization measurement was carried out at 10 mV for 3600 seconds. The initial current value at this time was represented by 10, and the current value in the steady state (3600 seconds later) was represented by Is. Subsequently, alternating-current impedance was measured from 1 Hz to 1 MHz. The resistance measured at this time was represented by Rs. The obtained values were substituted into expression (1) to obtain a lithium ion transport number t_{Li+}.

$${t}_{Li +} = \{ post - polarization current value Is ( A ) \times ( applied voltage V ( V ) - pre - polarization current value I 0 ( A ) \times pre - polarization impedance R 0 ( Ω ) ) \} / \{ pre - polarization current value I 0 ( A ) \times ( applied voltage V ( V ) - post - polarization current value Is ( A ) \times post - polarization impedance Rs ( Ω ) ) \} \qquad ( 1 )$$

### Example 2: PSTFSI-Li+SN

Production was carried out by the same method as in Example 1, except that PMTFSI-Li in Example 1 was changed to poly((trifluoromethane)sulfonimide lithium styrene) (PSTFSI-Li), and the lithium ion transport number was evaluated.

### Comparative Example 1: PEO+LiTFSI+SN

In Comparative Example 1, a polymer electrolyte was prepared to include polyethylene oxide (PEO) as a polymer with no anionic functional group, lithium bis(trifluoromethanesulfonyl)imide (LiTFSI) as a low molecular weight lithium salt, and succinonitrile (SN) as a substance having plastic crystal properties.

In an Ar atmosphere glove box, succinonitrile (produced by Sigma-Aldrich) and LiTFSI (produced by Sigma-Aldrich) were weighed out such that the molar ratio of SN to LiTFSI was 4:1, and the substances were stirred at 70° C. for 24 hours. To the obtained solution, 10 wt % of polyethylene oxide (PEO, produced by Sigma-Aldrich) with Mn=6000 was added, and the mixture was further stirred at 70° C. for 24 hours, thereby obtaining a polymer electrolyte. The obtained polymer electrolyte of Comparative Example 1 was evaluated in the same manner as in Example 1.

### Results

The results of the measurement of the lithium ion transport numbers for Examples 1 and 2 and Comparative Example 1 are shown in Table 1.

TABLE 1

| | | Lithium ion transport |
|---|---|---|
| | Component | number |
| Example 1 | PMTFSI-Li + SN | 0.82 |
| Example 2 | PSTFSI-Li + SN | 0.85 |
| Comparative Example 1 | PEO + LiTFSI + SN | 0.43 |

The results in Table 1 demonstrate that the polymer electrolytes of Examples 1 and 2 each including the lithium salt polymer including the anionic functional group exhibit higher lithium ion transport numbers than the polymer electrolyte of Comparative Example 1 including the polymer with no anionic functional group and the low molecular weight lithium salt.

What is claimed is:

1. A polymer electrolyte comprising a lithium salt polymer including an anionic functional group and a salt with lithium, and a substance having plastic crystal properties.

2. The polymer electrolyte according to claim 1, wherein the anionic functional group of the lithium salt polymer is present on a side chain of the lithium salt polymer.

3. The polymer electrolyte according to claim 1, wherein the substance having plastic crystal properties is succinonitrile.

4. The polymer electrolyte according to claim 1, wherein the anionic functional group of the lithium salt polymer includes a sulfonimide skeleton or an imide skeleton.

5. The polymer electrolyte according to claim 1, wherein the lithium salt polymer is poly((trifluoromethane)sulfonimide lithium methacrylate) or poly((trifluoromethane)sulfonimide lithium styrene).
